(19) United States
(12) Patent Application Publication
(10) Pub. No.: US 2023/0161309 A1
(43) Pub. Date: May 25, 2023

(54) Method for Optimizing Operation of Combined Cycle Gas Turbine System

(71) Applicant: Southwest Petroleum University, Chengdu (CN)

(72) Inventors: Xiaonan Wu, Chengdu (CN); Xusheng Wang, Chengdu (CN); Jiayuan Gou, Chengdu (CN); Hao Li, Chengdu (CN)

(21) Appl. No.: 17/836,303

(22) Filed: Jun. 9, 2022

(30) Foreign Application Priority Data
Nov. 22, 2021 (CN) 202111389037.4

(51) Int. Cl. G05B 19/042

(52) U.S. Cl. CPC G05B 19/042; G05B 2219/2639

(57) ABSTRACT

The present disclosure provides a method for optimizing operation of a combined cycle gas turbine system, which includes the following steps: firstly, building a process flow model of a gas-fired power generation system as well as a process flow model of a steam power generation system; then, determining energy efficiency indexes, an environmental evaluation index, and thermoeconomic evaluation indexes of the system; next, building an overall evaluation model by analyzing, through an entropy weight method, weight indexes such as a primary energy ratio, exergy efficiency, a per-unit emission amount of CO₂, and a per-unit thermoeconomic cost of the system; and finally, building an optimization model by means of particle swarm optimization.

### CROSS REFERENCE TO RELATED APPLICATION

This patent application claims the benefit and priority of Chinese Patent Application No. 202111389037.4, filed on Nov. 22, 2021, the disclosure of which is incorporated by reference herein in its entirety as part of the present application.

### TECHNICAL FIELD

The present disclosure relates to the technical field of energy utilization, in particular to a method for optimizing operation of a combined cycle gas turbine system.

### BACKGROUND

The sustained and effective energy supply is essential to the economic and social development. An important measure for national green energy reform is to replace coal-fired power generation systems with clean, low-carbon, and high-efficient gas-fired power generation systems. The combined cycle gas turbine system composed of a gas turbine and a steam turbine is regarded as the existing gas-fired power generation system having the highest efficiency, the most remarkable economy, and the most excellent environmental friendliness. The operating efficiency of the combined cycle gas turbine systems is considerably higher than that of the single Brayton cycle system or Rankine cycle system. The operating loads of the combined cycle gas turbine systems mainly used for regional power supply and peak regulation domestically are primarily affected by the load demand of users and the power supply of other power generation systems. For this reason, the combined cycle gas turbine systems operate in a case of variable loads according to the quantity of peak regulation needed by the users. To improve the energy efficiency, environmental friendliness, and economy of the combined cycle gas turbine systems in different seasons, a method for building an overall evaluation model of the combined cycle gas turbine systems is studied, and a method for optimizing operation of the combined cycle gas turbine systems in different seasons is put forward.

The combined cycle gas turbine systems as complex power generation systems are affected by many factors on the aspect of overall effectiveness. For the sake of the optimal operating condition of the systems, researchers concentrate on studying how to optimize the main parameters of the systems. From the analysis on literature related to the study on the overall evaluation and operation optimization of the systems, most researchers currently optimize the inlet guide vane (IGV) opening and natural gas flow of the systems under different load conditions to improve the power generation efficiency of the systems without considering the energy efficiency, environmental friendliness, and economy of the systems, and the studies on optimizing the operation to improve the overall effectiveness of the systems are rarely performed. In view of the carbon peaking and carbon neutrality goals as well as rising energy prices, a method for optimizing the operation of the systems in the case of variable loads is urgently needed to guarantee the energy efficiency, environmental friendliness, and economy of the systems.

### SUMMARY

The objective of the present disclosure is to provide a method for optimizing operation of a combined cycle gas turbine system to improve overall effectiveness such as energy efficiency, environmental friendliness, and economy of the system, aiming at obtaining the optimal operation conditions of the system in different seasons.

The method for optimizing operation of a combined cycle gas turbine system of the present disclosure is mainly designed as follows:

(1) a complete thermoeconomic modeling process of the combined cycle gas turbine system is summarized based on thermoeconomic analysis to analyze the energy efficiency and economy of the system;

(2) an overall evaluation model capable of objectively evaluating the energy efficiency, environmental friendliness, and economy of the system is built through an entropy weight method; and

(3) the method for optimizing operation of the combined cycle gas turbine system in a case of variable loads by means of the overall evaluation model is put forward.

The method for optimizing operation of a combined cycle gas turbine system of the present disclosure particularly includes the following steps:

S1, building, based on an actual production process of a combined cycle gas turbine system, a process flow model of a gas-fired power generation system as well as a process flow model of a steam power generation system of the combined cycle gas turbine system by means of process simulation software, namely Aspen Plus, and thermodynamic models of devices of the combined cycle gas turbine system;

S2, determining energy efficiency indexes and an environmental evaluation index of the combined cycle gas turbine system;

particularly, establishing a primary energy ratio index by analyzing, based on energy analysis, an energy balance among a gas turbine system, a waste heat boiler system, and a steam turbine system;

where, the primary energy ratio of the combined cycle gas turbine system is expressed as follows:

$${η}_{Q} = 1 - \frac{\sum {Q}_{si}}{{Q}_{fuel}} = \frac{{W}_{1} + {W}_{2}}{{Q}_{fuel}} \qquad ( 2 - 1 )$$

in formula (2-1), Qₛᵢ represents an energy loss of each part, which is measured in kJ/s;

Q_{fuel} represents a lower heating value of a fuel entering the gas turbine system, which is measured in kJ/s;

W₁ represents electric energy generated by the gas turbine system, which is measured in kJ/s; and

W₂ represents electric energy generated by the steam turbine system, which is measured in kJ/s;

establishing an exergy efficiency index by analyzing, based on exergy analysis, an exergy balance among main devices of the combined cycle gas turbine system;

$${η}_{Ex} = \frac{{\sum }_{x}^{n} {E}_{in , x} - \sum I}{{\sum }_{x}^{n} {E}_{in , x}} \qquad ( 2 - 2 )$$

in formula (2-2), E_{in,x} represents a value of an exergy flow entering the system, which is measured in kJ/s; and

I represents an exergy loss of the system, which is measured in kJ/s;

where, the primary energy ratio and exergy efficiency of the system are served as the energy efficiency indexes of the system;

analyzing components of a flue gas from the system, where mass of CO₂ emitted by the system to generate per-unit electricity is served as the environmental evaluation index;

$${λ}_{{CO}_{2}} = \frac{{m}_{{CO}_{2}}}{{W}_{e}} \qquad ( 2 - 3 )$$

$${m}_{{CO}_{2}} = {m}_{gas} \cdot \frac{{M}_{{CO}_{2}}}{{M}_{gas}} \qquad ( 2 - 4 )$$

in formula (2-3) and formula (2-4), λ_{CO2} represents an amount of the CO₂ emitted by the system to generate per-unit electricity, which is measured in g/(kW·h);

M_{CO2} represents an amount of CO₂ in the flue gas, which is measured in g/kg; and

M_{CO2} represents molar mass of the CO₂ in the flue gas, which is measured in kg/mol; and M_{gas} represents molar mass the flue gas, which is measured in kg/mol;

S3, determining thermoeconomic evaluation indexes of the combined cycle gas turbine system;

particularly, build thermoeconomic models of the system by analyzing, based on a structural theory of thermoeconomics, a production structure of the system as well as fuels and products of the devices of the system; where, the thermoeconomic models are built through the following steps:

(1) drawing a productive structure diagram of the system according to a productive consumption relationship between fuels and the devices of the system and between products and the devices of the system;

(2) building fuel-product calculation models of the devices of the system, to determine the fuels and the products; and

(3) building thermoeconomic models of the devices of the system to analyze a thermoeconomic cost of the system;

through analysis on composition of the thermoeconomic cost of the system, analyzing, based on operating parameters of the system under a basic operating condition, the thermoeconomic cost of the system under the basic operating condition by means of the thermoeconomic models to evaluate the economy of the system;

S4, building the overall evaluation model by analyzing, through an entropy weight method, weight indexes such as the primary energy ratio, the exergy efficiency, the per-unit emission amount of the CO₂, and the per-unit thermoeconomic cost of the system;

where, the overall evaluation model is particularly built through the following steps:

S41, normalization of the indexes

firstly, totally numbering m operating conditions, participating in evaluation, of the system as M, where M=(m₁, m₂, m₃ . . . mₘ); totally numbering n evaluation indexes of the system as D, where D=(d₁, d₂, d₃ . . . dₙ); and recording a value of the j^{th} evaluation index of the evaluated operating condition mᵢ as xᵢⱼ to form an evaluation index matrix X=[xᵢⱼ]_{m*n} composed of m*n indexes;

$$X = [ \begin{matrix}{x}_{11} & {x}_{12} & L & {x}_{1 n} \\ {x}_{21} & {x}_{22} & L & {x}_{2 n} \\ M & M & O & M \\ {x}_{m 1} & {x}_{m 2} & L & {x}_{mn}\end{matrix} ] \qquad ( 4 - 1 )$$

then, further normalizing the indexes based on their types, where the indexes expressing performance improved with an increase in values of evaluation results are normalized according to formula (4-2), and indexes expressing the performance improved with a decrease in values of evaluation results are normalized according to formula (4-3);

$${V}_{ij} = \frac{{x}_{ij} - min ( {x}_{j} )}{max ( {x}_{j} ) - min ( {x}_{j} )} \qquad ( 4 - 2 )$$

$${V}_{ij} = \frac{max ( {x}_{j} ) - {x}_{ij}}{max ( {x}_{j} ) - min ( {x}_{j} )} \qquad ( 4 - 3 )$$

in formula (4-2) and formula (4-3), min(xⱼ) represents the minimum value of the j^{th} evaluation index under the operating conditions; and

max(xⱼ) represents the maximum value of the j^{th} evaluation index under the operating conditions;

and finally, calculating a proportion of features of the i^{th} load condition in the presence of the j^{th} evaluation index to form a normalized matrix P expressed by formula (4-4);

$${P}_{i j} = \frac{{V}_{i j}}{{{\sum }_{i = 1}}^{m} {V}_{i j}} \qquad ( 4 - 4 )$$

in formula (4-4), Vᵢⱼ represents a value of a normalized and dimensionless index xᵢⱼ; and

Pᵢⱼ represents the proportion of the features;

S42, information entropy calculation on the indexes

working out a value of information entropy corresponding to the j^{th} evaluation index according to formula (4-5);

$${e}_{j} = - 1 / ln ( m ) {\sum }_{i = 1}^{m} {p}_{ij} \cdot ln {p}_{ij} \qquad ( 4 - 5 )$$

in formula (4-5), eⱼ represents the value of the information entropy of the j^{th} evaluation index, and Pᵢⱼ represents the proportion of the features;

S43, weight calculation on the indexes

working out a difference coefficient of the evaluation index xⱼ according to formula (4-6), and working out an entropy weight wⱼ of the j^{th} evaluation index according to formula (4-7):

$${d}_{j} = 1 - {e}_{j} \qquad ( 4 - 6 )$$

$${w}_{j} = \frac{{d}_{j}}{{\sum }_{j = 1}^{n} {d}_{j}} \qquad ( 4 - 7 )$$

in formula (4-6) and formula (4-7), dⱼ represents a difference of the j^{th} evaluation index; and

wⱼ represents a weight ratio of the j^{th} evaluation index;

S44, calculation on overall evaluation indexes

where, an overall effectiveness evaluation index Kᵢ under the i^{th} operating condition is as follows:

$${K}_{i} = {\sum }_{j = 1}^{n} {w}_{j} {V}_{ij} \qquad ( 4 - 8 )$$

S5, building an optimization model by means of particle swarm optimization;

particularly, in order to obtain the optimal operating parameters in a case of variable loads of the system, build, by means of the particle swarm optimization, the optimization model of the system with IGV opening of an air compressor and natural gas flow as variables to obtain the highest overall evaluation of the system; where detailed steps are as follows:

in order to improve the primary energy ratio and exergy efficiency of the system and reduce the per-unit emission amount of the CO₂ and per-unit thermoeconomic cost of the system under different operating conditions, setting the overall evaluation model as an optimization objective;

in order to guarantee safe operation of the system and satisfy the demand of users for electric loads, establishing constraint conditions of the system;

establishing an adaptive function group, where independent variables of the adaptive function group include the IGV opening to be optimized, the natural gas flow, and a natural gas price having an influence on the per-unit thermoeconomic cost of the system; and dependent variables include the primary energy ratio, the exergy efficiency, the per-unit emission amount of the CO₂, and the per-unit thermoeconomic cost which are related to the optimization objective, as well as an operating load of the system and an outlet flue gas temperature of a gas turbine, which are related to the constraint conditions; and

after the optimization objective, the constraint conditions, and the adaptive function group are determined, building the operation optimization model according to a calculation process of the particle swarm optimization by writing calculation codes through matlab.

Compared with the prior art, the present disclosure has the following beneficial effects.

The complete thermoeconomic modeling process of the combined cycle gas turbine system is summarized based on the thermoeconomic analysis to analyze the energy efficiency and economy of the system. The per-unit thermoeconomic cost needed by the system to generate the per-unit electric energy is included in the overall evaluation model. The overall evaluation model capable of objectively evaluating the energy efficiency, environmental friendliness, and economy of the system is built through the entropy weight method. After the overall evaluation model of the system is built, the optimal IGV opening and optimal natural gas flow of the system are obtained for the purpose of the highest overall evaluation of the system

In the present disclosure, fitting is performed on a functional relationship between overall evaluation results and major control parameters (the IGV opening and the natural gas flow) of the combined cycle gas turbine system, and the process flow models are combined with the overall evaluation model. For the purpose of the highest overall evaluation of the system, the operation of the system under different load conditions in spring, summer, autumn, and winter is optimized by means of the particle swarm optimization

Other advantages, objects, and features of the present disclosure will be partially embodied through the following description, and some will be understood by those skilled in the art through the research and practice for the present disclosure.

### BRIEF DESCRIPTION OF THE DRAWINGS

FIG. 1 shows a flow chart of a method for optimizing operation of a combined cycle gas turbine system of the present disclosure;

FIG. 2 shows a process flow model of a gas-fired power generation system in an embodiment of the present disclosure;

Reverence numerals: COMPRESS-air compressor; COMBUST-combustion chamber; TURBINE-turbine;

FIG. 3 shows a process flow model of a steam power generation system in the embodiment of the present disclosure;

Reference numerals: RHEAT2—intermediate-pressure reheater 2; HSUP2—high-pressure superheater 2; RHEAT1—intermediate-pressure reheater 1; HSUP1—high-pressure superheater 1; HVAPOR—high-pressure evaporator; HECONOMI—high-pressure economizer; MSUP—intermediate-pressure superheater; MVAPOR—intermediate-pressure evaporator; MECONO MI—intermediate-pressure economizer; LSUP—low-pressure superheater; LVAPOR—low-pressure evaporator; HEAT—feedwater heater; HDRUM—high-pressure steam drum; IDRUM—intermediate-pressure steam drum; LDRUM—low-pressure steam drum; HPC—high-pressure cylinder of a steam turbine; IPC—intermediate-pressure cylinder of the steam turbine; LPC—low-pressure cylinder of the steam turbine; COND—condenser; CPUMP—condensate pump; IPUMP—intermediate-pressure water-delivery pump; HPUMP—high-pressure water-delivery pump;

FIG. 4 shows a productive structure diagram a combined cycle gas turbine system in a city in the embodiment of the present disclosure;

FIG. 5 shows per-unit thermoeconomic costs of main productive devices;

FIG. 6 shows composition of the per-unit thermoeconomic costs of the main productive devices;

FIG. 7 shows a change of air flow along with that of IGV opening of the combined cycle gas turbine system;

FIG. 8 shows a calculation process of particle swarm optimization;

FIG. 9 shows overall evaluation results of the system before and after optimization in spring;

FIG. 10 shows overall evaluation results of the system before and after the optimization in summer;

FIG. 11 shows overall evaluation results of the system before and after the optimization in autumn; and

FIG. 12 shows overall evaluation results of the system before and after the optimization in winter.

### DETAILED DESCRIPTION OF THE EMBODIMENTS

The preferred embodiments of the present disclosure are described below with reference to the drawings. It should be understood that the preferred embodiments described herein are only used to illustrate the present disclosure, rather than to limit the present disclosure.

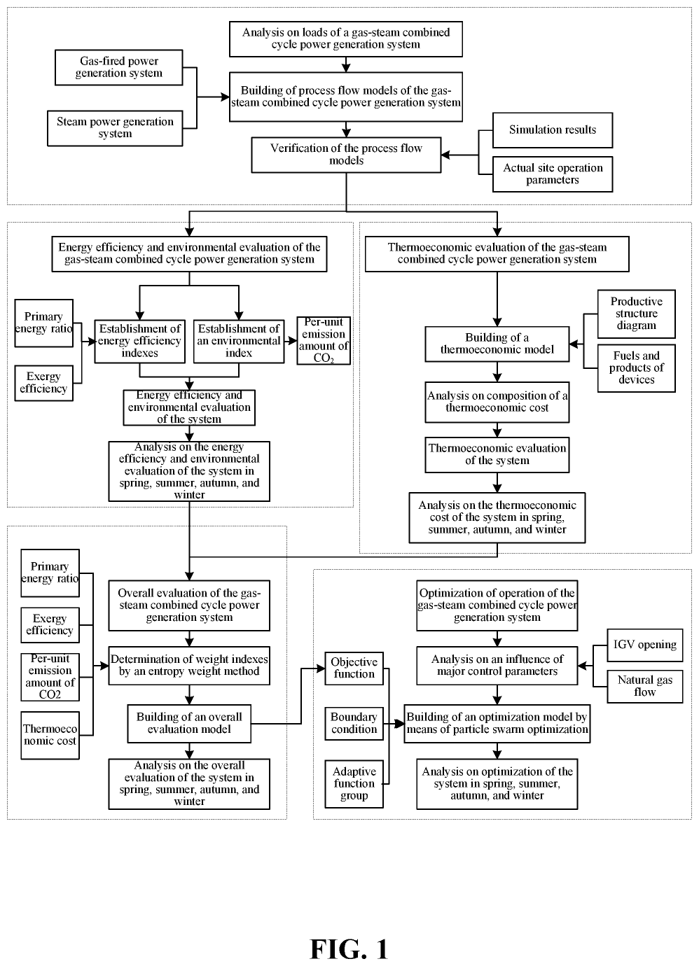

A method for optimizing operation of a combined cycle gas turbine system of the present disclosure is explained in detail with a combined cycle gas turbine system in a city as an example. As shown in FIG. 1 to FIG. 12, the method includes steps S1-S5.

S1, Build process flow models;

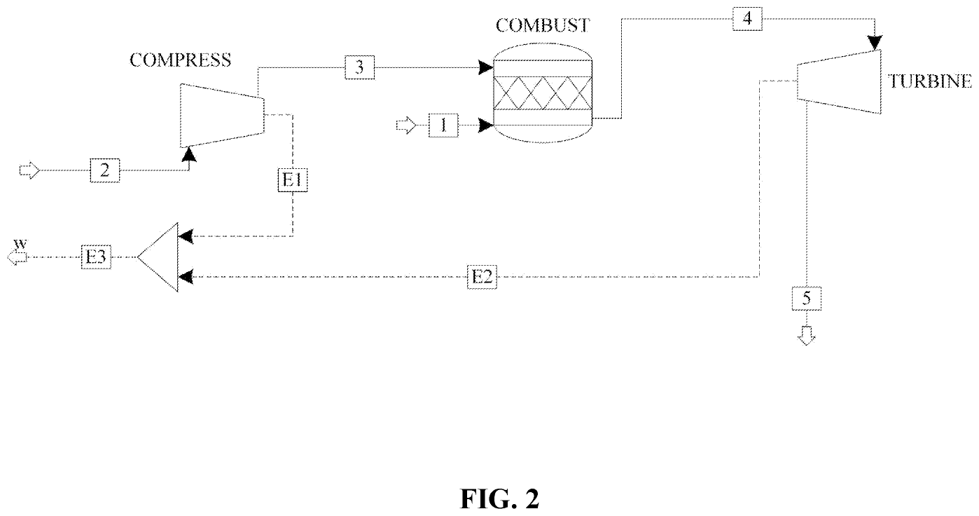

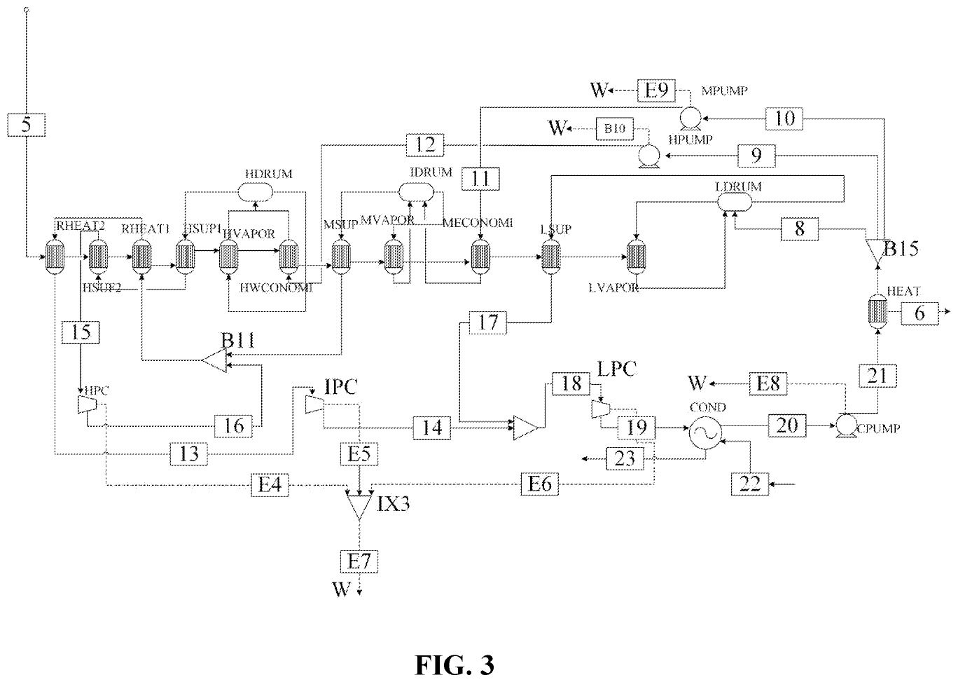

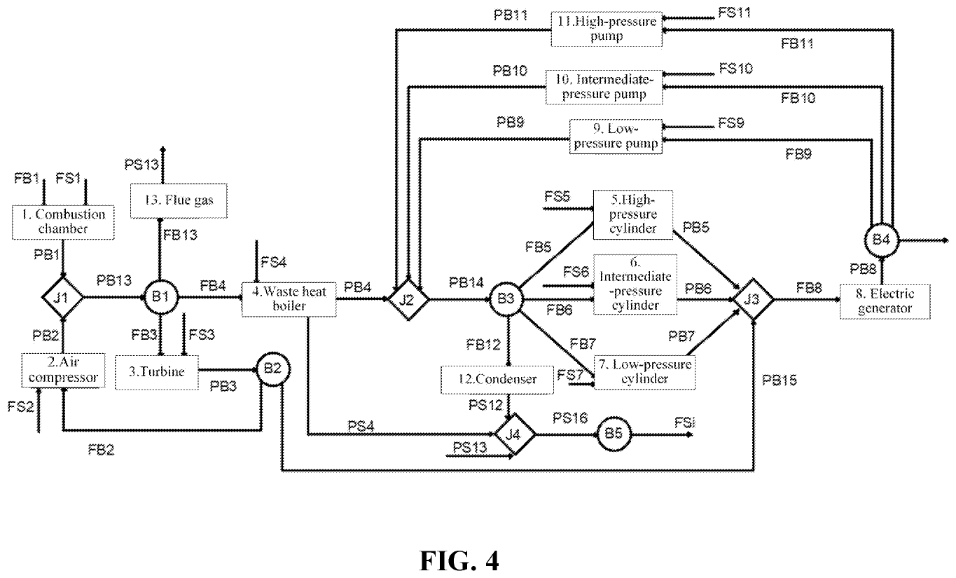

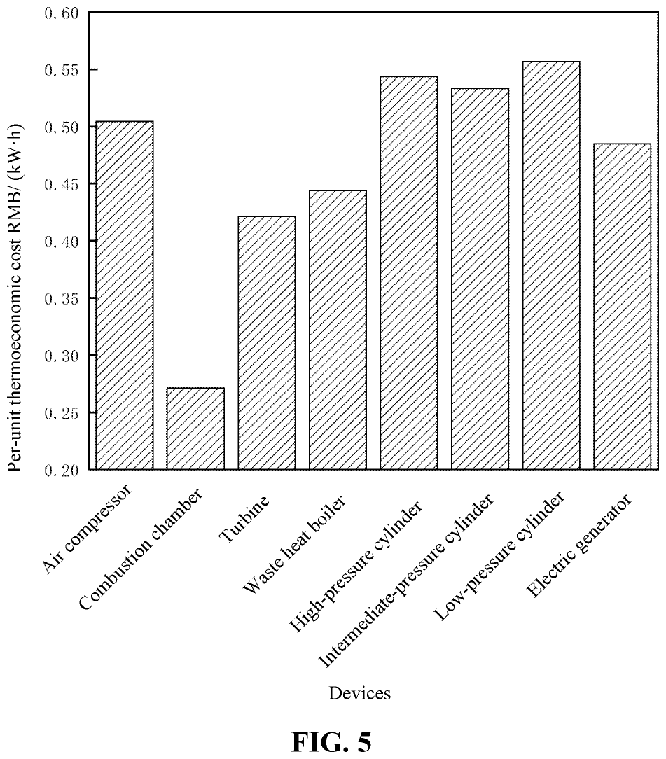

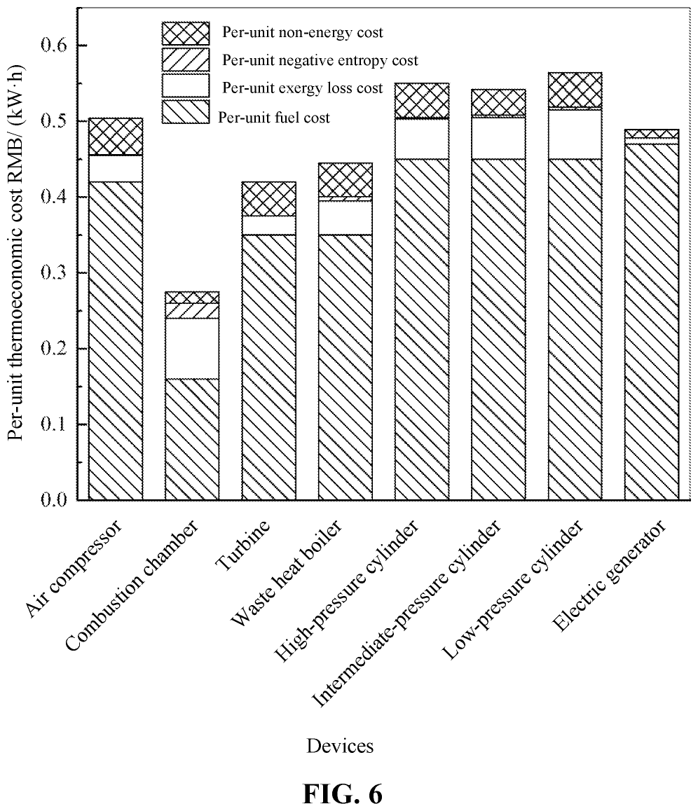

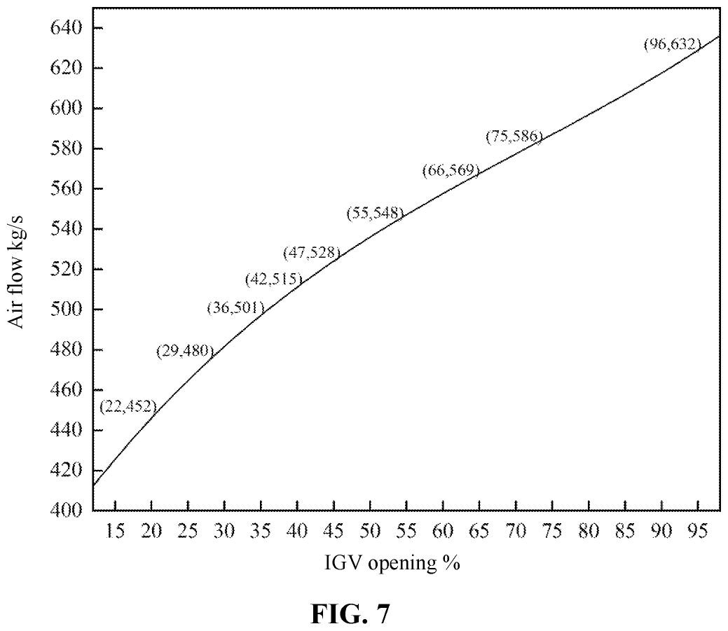

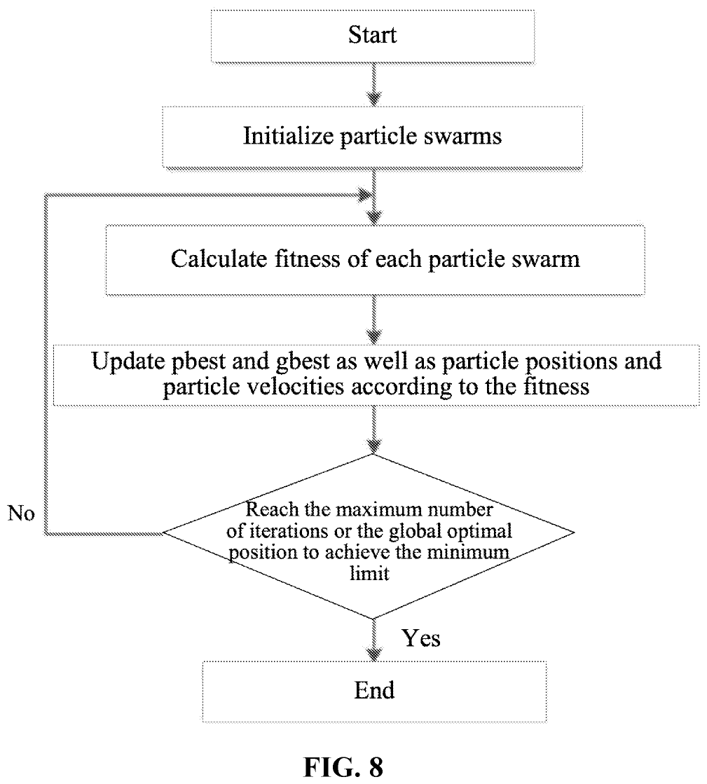

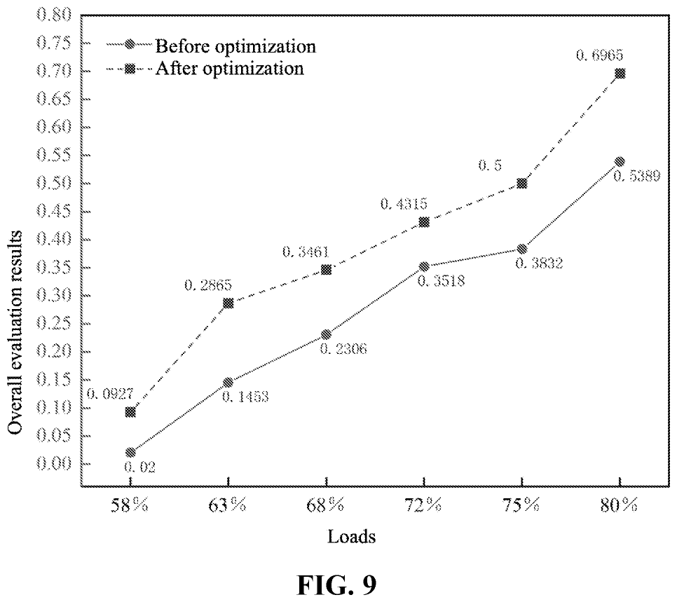

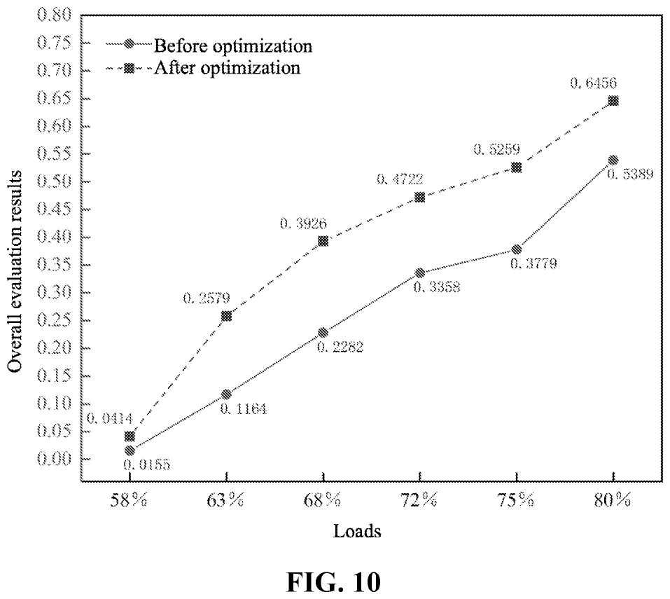

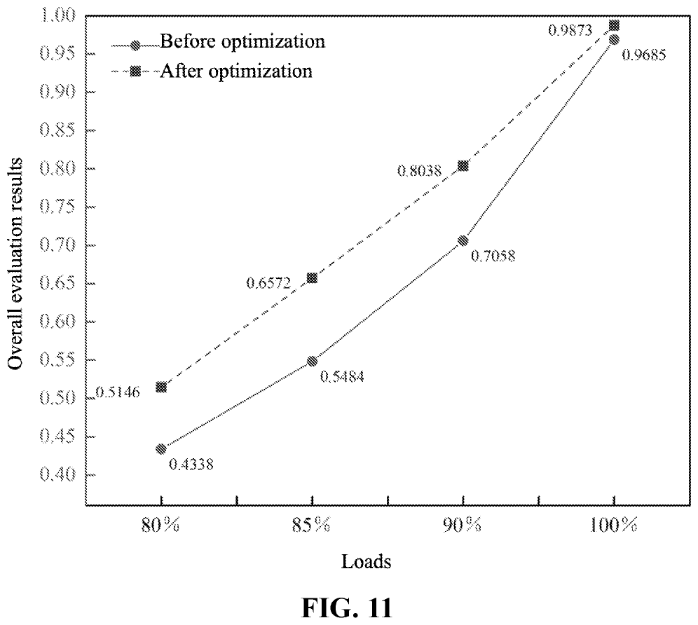

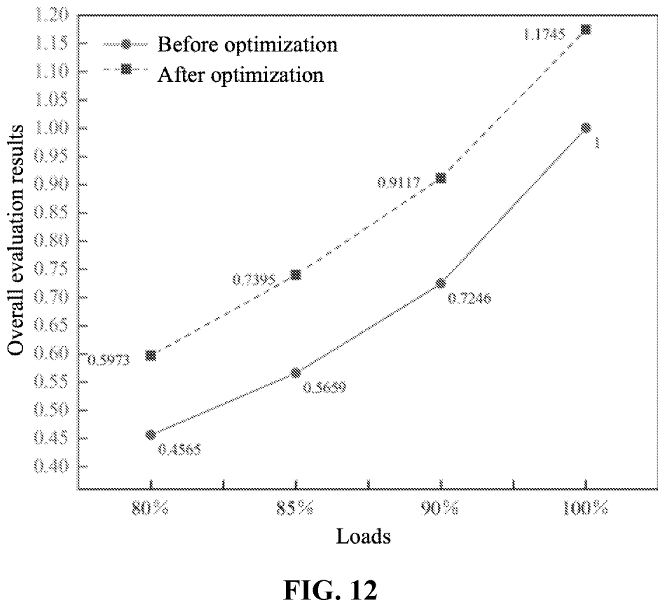

Particularly, build the process flow models of the combined cycle gas turbine system in the city by means of Aspen Plus; Where, the process flow model of a gas-fired power generation system is shown in FIG. 2; and the process flow model of a steam power generation system is shown in FIG. 3.

S2, Determine energy efficiency indexes and an environmental evaluation index of the combined cycle gas turbine system;

Particularly, establish a primary energy ratio index by analyzing, based on energy analysis, an energy balance among a gas turbine system, a waste heat boiler system, and a steam turbine system;

Where, the primary energy ratio of the combined cycle gas turbine system is expressed as follows:

$${η}_{Q} = 1 - \frac{\sum {Q}_{si}}{{Q}_{fuel}} = \frac{{W}_{1} + {W}_{2}}{{Q}_{fuel}} ; \qquad ( 2 - 1 )$$

In formula (2-1), Qₛᵢ represents an energy loss of each part, which is measured in kJ/s;

Q_{fuel} represents a lower heating value of a fuel entering the gas turbine system, which is measured in kJ/s;

W₁ represents electric energy generated by the gas turbine system, which is measured in kJ/s; and

W₂ represents electric energy generated by the steam turbine system, which is measured in kJ/s;

establishing an exergy efficiency index by analyzing, based on exergy analysis, an exergy balance among main devices of the combined cycle gas turbine system;

$${η}_{Ex} = \frac{{\sum }_{x}^{n} {E}_{in , x} - \sum I}{{\sum }_{x}^{n} {E}_{in , x}} ; \qquad ( 2 - 2 )$$

In formula (2-2), E_{in,x} represents a value of an exergy flow entering the system, which is measured in kJ/s; and

I represents an exergy loss of the system, which is measured in kJ/s;

Where, the primary energy ratio and exergy efficiency of the system are served as the energy efficiency indexes of the system;

Analyze components of a flue gas from the system, where the mass of CO₂ emitted by the system to generate per-unit electricity is served as the environmental evaluation index;

$${λ}_{{CO}_{2}} = \frac{{m}_{{CO}_{2}}}{{W}_{e}} ; \qquad ( 2 - 3 )$$

$${m}_{{CO}_{2}} = {m}_{g a s} \cdot \frac{{M}_{{CO}_{2}}}{{M}_{g a s}} ; \qquad ( 2 - 4 )$$

In formula (2-3) and formula (2-4), λ_{CO2} represents an amount of the CO₂ emitted by the system to generate the per-unit electricity, which is measured in g/(kW·h);

M_{CO2} represents an amount of CO₂ in the flue gas, which is measured in g/kg; and

M_{CO2} represents molar mass of the CO₂ in the flue gas, which is measured in kg/mol; and M_{gas} represents molar mass the flue gas, which is measured in kg/mol.

The primary energy ratio of the combined cycle gas turbine system in the city is 55.56%. The exergy efficiency of the system is 52.84%, and the amount of the CO₂ emitted by the system to generate the per-unit electricity is calculated as 1287.31 g/(kW·h).

S3, Determine thermoeconomic evaluation indexes of the combined cycle gas turbine system;

(1) draw a productive structure diagram, as shown in FIG. 4, of the system according to a productive consumption relationship between fuels and the devices of the system and between products and the devices of the system;

(2) Build fuel-product calculation models of the devices of the system, as shown in table 1;

TABLE 1
Fuel-product calculation models

| Device in the system | | Fuel | Product |
|---|---|---|---|
| Gas turbine system | Combustion chamber | FB = E₁ | PB = E₃ − E₄ |
| | | FS = T₀(S₃ − S₄) | |
| | Air compressor | FB = E₂₃ | PB = E₃ − E₂ |
| | | FS = T₀(S₃ − S₂) | |
| | Turbine | FB = E₄ − E₅ | PB = E₂₂ + E₂₃ |
| | | FS = T₀(S₄ − S₅) | |
| Waste heat boiler system | | FB = E₅ − E₆ | PB = E₁₃ + E₁₅ + T₁₇ + E₇ − |
| | | FS = T₀(S₁₃ + S₁₅ + S₁₇ + S₇ − | E₈ − E₁₁ − E₁₂ − E₁₆ − E₂₁ |
| | | S₈ − S₁₁ − S₁₂ − S₁₆ − S₂₁) | PS = T₀ (S₅ − S₆) |
| Steam turbine system | High-pressure cylinder | FB = E₁₅ − E₁₆ | PB = E₂₄ |
| | | FS = T₀(S₁₅ − S₁₆) | |
| | Intermediate-pressure cylinder | FB = E₁₃ − E₁₄ | PB = E₂₅ |
| | | FS = T₀(S₁₃ − S₁₄) | |
| | Low-pressure cylinder | FB = E₁₈ − S₁₄ | PB = E₂₆ |
| | | FS = T₀(S₁₈ − S₁₉) | |
| | Condenser | FB = E₁₉ − E₂₀ | FS = T₀(S₁₉ − S₂₀) |
| Pump system | Low-pressure pump | FB = E₂₇ | PB = E₂₁ − E₂₀ |
| | | FS = T₀(S₂₁ − S₂₀) | |
| | Intermediate-pressure pump | FB = E₂₉ | PB = E₁₁ − E₉ |
| | | FS = T₀(S₁₁ − S₉) | |
| | High-pressure pump | FB = E₂₈ | PB = E₁₂ − E₁₀ |
| | | FS = T₀(S₁₂ − S₁₀) | |

| | | |
|---|---|---|
| Electric generator | FB = E₂₂ + E₂₄ + E₂₅ + E₂₆ | PB = E₃₀ |
| Chimney | FB = E₆ | FS = T₀S₆ |

(3) Build thermoeconomic models (as shown in table 2) of the devices of the combined cycle gas turbine system to analyze a thermoeconomic cost (as shown in FIG. 5) of the system; and

TABLE 2
Thermoeconomic models of the devices of the combined cycle gas turbine system

| Device in the system | | Thermoeconomic model |
|---|---|---|
| Gas turbine system | Combustion chamber | PB₁ · C_{PB, 1} = FB₁ · C_{FB, 1} + FS₁ · C_{FS, 1} + Z₁ |
| | Air compressor | PB₂ · C_{PB, 2} = FB₂ · C_{FB, 2} + FS₂ · C_{FS, 2} + Z₂ |
| | Turbine | PB₃ · C_{PB, 3} = FB₃ · C_{FB, 3} + FS₃ · C_{FS, 3} + Z₃ |
| Waste heat boiler system | | PB₄ · C_{PB, 4} + PS₄ · C_{PS, 4} = FB₄ · C_{FB, 4} + FS₄ · C_{FS, 4} + Z₄ |
| Steam turbine system | High-pressure cylinder | PB₅ · C_{PB, 5} = FB₅ · C_{FB, 5} + FS₅ · C_{FS, 5} + Z₅ |
| | Intermediate-pressure cylinder | PB₆ · C_{PB, 6} = FB₆ · C_{FB, 6} + FS₆ · C_{FS, 6} + Z₆ |
| | Low-pressure cylinder | PB₇ · C_{PB, 7} = FB₇ · C_{FB, 7} + FS₇ · C_{FS, 7} + Z₇ |
| | Condenser | PS₁₂ · C_{PS, 12} = FB₁₂ · C_{FB, 12} + Z₁₂ |
| Pump system | Low-pressure pump | PB₉ · C_{PB, 9} = FB₉ · C_{FB, 9} + F₉ · C_{FS, 9} + Z₉ |
| | Intermediate-pressure pump | PB₁₀ · C_{PB, 10} = FB₁₀ · C_{FB, 10} + FS₁₀ · C_{FS, 10} + Z₁₀ |
| | High-pressure pump | PB₁₁ · C_{PB, 11} = FB₁₁ · C_{FB, 11} + FS₁₁ · C_{FS, 11} + Z₁₁ |

| | |
|---|---|
| Electric generator | PB₈ · C_{PB, 8} = FB₈ · C_{FB, 8} + Z₈ |
| Flue gas | PS₁₃ · C_{PS, 13} = FB₁₃ · C_{FB, 13} + Z₁₃ |
| J1 | C_{PB, 14} = Σrᵢ · C_{PB, i}(i = 1, 2) |
| J2 | C_{PB, 15} = Σrᵢ · C_{PB, i}(i = 4, 9, 10, 11) |
| J3 | C_{FB, 8} = Σrᵢ · C_{PB, i}(i = 5, 6, 7, 16) |
| J4 | C_{PS, 17} = Σrᵢ · C_{PS, i}(i = 4, 12, 13) |
| B1 | C_{FB, j} = C_{PB, 14}(j = 3, 4, 13) |
| B2 | C_{PB, j} = C_{FB, 2}(j = 3, 16) |
| B3 | C_{FB, j} = C_{PB, 15}(j = 5, 6, 7, 12) |
| B4 | C_{FB, j} = C_{PB, 8}(j = 9, 10, 11) |
| B5 | C_{FS, j} = C_{PS, 17}(j = 1, 2, 3, 4, 5, 6, 7, 9, 10, 11) |

(4) Through analysis on composition (as shown in FIG. 6) of the thermoeconomic cost of the system, analyze, based on operating parameters of the system under a basic operating condition, the thermoeconomic cost of the system under the basic operating condition by means of the thermoeconomic models to evaluate the economy of the system.

With respect to the combined cycle gas turbine system in the city, the low-pressure cylinder has the highest per-unit thermoeconomic cost of 0.5567 yuan/(kW·h); and the combustion chamber has the lowest per-unit thermoeconomic cost of 0.2714 yuan/(kW·h). A product of the electric generator is equivalent to the electric energy generated by the system. Therefore, the per-unit thermoeconomic cost of 0.4848 yuan/(kW·h) is equivalent to the per-unit power generation cost of the system.

S4, Build an overall evaluation model of the combined cycle gas turbine system;

Where, a method for building the overall evaluation model is put forward to overall evaluate the energy efficiency, environmental friendliness, and economy of the system; Particularly, build the overall evaluation model by analyzing, through an entropy weight method, weight indexes such as the primary energy ratio, the exergy efficiency, the per-unit emission amount of the CO₂, and the per-unit thermoeconomic cost of the system; where, detailed steps are as follows:

(1) Normalization of the indexes, as shown in table 3;

TABLE 3
Normalization results of a feature proportion matrix

| | | | Per-unit | |
|---|---|---|---|---|
| | Thermal | Exergy | emission | Per-unit |
| Operating | efficiency | efficiency | amount Pᵢ₃ | thermoeconomic |
| condition | Pᵢ₁ | Pᵢ₂ | of the CO2 | cost Pᵢ₄ |
| m₁ | 0.0545 | 0.0553 | 0.0546 | 0.0821 |
| m₂ | 0.0342 | 0.0379 | 0.0347 | 0.0653 |
| m₃ | 0.0327 | 0.0361 | 0.0333 | 0.0571 |
| m₄ | 0.0125 | 0.0188 | 0.0306 | 0.0401 |
| m₅ | 0.0122 | 0.0178 | 0.0126 | 0.0231 |
| m₆ | 0.0034 | 0.0027 | 0.0032 | 0.0007 |
| m₇ | 0.0519 | 0.0540 | 0.0520 | 0.0812 |
| m₈ | 0.0316 | 0.0341 | 0.0323 | 0.0641 |
| m₉ | 0.0275 | 0.0300 | 0.0308 | 0.0553 |
| m₁₀ | 0.0093 | 0.0145 | 0.0305 | 0.0389 |
| m₁₁ | 0.0029 | 0.0099 | 0.0097 | 0.0207 |
| m₁₂ | 0.0000 | 0.0000 | 0.0000 | 0.0000 |
| m₁₃ | 0.1395 | 0.1181 | 0.1189 | 0.0869 |
| m₁₄ | 0.0918 | 0.0885 | 0.0893 | 0.0641 |
| m₁₅ | 0.0703 | 0.0709 | 0.0688 | 0.0481 |
| m₁₆ | 0.0560 | 0.0580 | 0.0561 | 0.0339 |
| m₁₇ | 0.1442 | 0.1237 | 0.1229 | 0.0884 |
| m₁₈ | 0.0941 | 0.0921 | 0.0915 | 0.0653 |
| m₁₉ | 0.0726 | 0.0750 | 0.0694 | 0.0496 |
| m₂₀ | 0.0589 | 0.0623 | 0.0587 | 0.0353 |

(2) Information entropy calculation on the indexes based on formula (4-5), where calculation results are shown in table 4;

(3) Weight calculation on the indexes based on formula (4-6) and formula (4-7), where calculation results are shown in table 4; and

TABLE 4
Calculation results of the entropy weight method

| | | | Per-unit | |
|---|---|---|---|---|
| | Primary | Exergy | emission | Per-unit |
| | energy | efficiency | amount V₃ | thermoeconomic |
| | ratio V₁ | V₂ | of CO₂ | cost V₄ |
| Information entropy eⱼ | 0.3793 | 0.3680 | 0.3656 | 0.3514 |
| Difference dⱼ | 0.6207 | 0.6320 | 0.63442 | 0.6486 |
| Weight wⱼ | 0.2448 | 0.2492 | 0.2502 | 0.2558 |

(4) Weight calculation on the indexes;

Particularly, substitute the weight of each evaluation index into formula (4-8) to build the following overall effectiveness evaluation model of the combined cycle gas turbine system in the city;

$$\begin{matrix}{K}_{i} = 0.2448 {V}_{i 1} + 0.2492 {V}_{i 2} + 0.2502 {V}_{i 3} + 0.2558 {V}_{i 4} \\ = 0.2448 \times \frac{{η}_{Q} - 50.18}{5.56} + 0.2492 \times \frac{{η}_{E x} - 47.61}{5.48} + 0.2502 \times \frac{1405.16 - {m}_{{CO}_{2}}}{127.48} \\ + 0.2558 \times \frac{0.6417 - {C}_{8}}{0.1076}\end{matrix} . \qquad ( 4 - 9 )$$

S5, Build an optimization model by means of particle swarm optimization;

Particularly, in order to obtain the optimal operating parameters in a case of variable loads of the system, build, by means of the particle swarm optimization, the optimization model of the system with IGV opening of an air compressor and natural gas flow as variables to obtain the highest overall evaluation of the system. A change of air flow along with that of the IGV opening is shown in FIG. 7. A process of the particle swarm optimization is shown in FIG. 8.

The overall evaluation model is particularly built through the following steps:

(1) Optimization Objective

In order to improve the primary energy ratio and exergy efficiency of the system and reduce the per-unit emission amount of the CO₂ and per-unit thermoeconomic cost of the system under different operating conditions, set the built overall evaluation model (4-9) of the combined cycle gas turbine system as the optimization objective;

(2) Constraint Conditions

In order to guarantee safe operation of the system and satisfy the demand of users for electric loads, establish the constraint conditions of the system, which are expressed by formula 5-1; where, with a combined cycle gas turbine system in Dazhou as an example, an outlet flue gas temperature of a gas turbine should not be higher than 600° C., and the IGV opening ranges from 12% to 98%; only in this case, the system can operate safely; and in order to make the electricity generated by the system be adequate for the electric loads needed by the users, a power generation load of the system is equalized to a needed power generation load;

$$s . t . \{ \begin{matrix}max [ {K}_{i} ] \\ {T}_{6} ⩽ {T}_{6 , max} \\ {α}_{min} ⩽ α ⩽ {α}_{max} \\ {Load}_{e} = {Load}_{need}\end{matrix} \qquad ( 5 - 1 )$$

In formula (5-1), T_{6,max} represents the maximum allowable outlet flue gas temperature, namely 600° C., of the gas turbine;

αₘᵢₙ represents the minimum value, namely 12%, of the IGV opening, and αₘₐₓ represents the maximum value, namely 98%, of the IGV opening; and

Laodₑ represents the power generation load of the system, and Load_{need} represents the needed power generation load;

(3) Establishment of an Adaptive Function Group

In the particle swarm optimization, independent variables are required to be substituted into the adaptive function group to determine current “positions” of particles. The independent variables of the adaptive function group include the IGV opening to be optimized, the natural gas flow, and a natural gas price having an influence on the per-unit thermoeconomic cost of the system. Dependent variables include the primary energy ratio, the exergy efficiency, the per-unit emission amount of the CO₂, and the per-unit thermoeconomic cost which are related to the optimization objective, as well as the operating load of the system and the outlet flue gas temperature of the gas turbine, which are related to the constraint conditions.

The adaptive function group is particularly established through the following steps:

Firstly, simulate, by means of the process flow model, operating conditions of the combined cycle gas turbine system in Dazhou in a case where the IGV opening ranges from 12% to 98% and the natural gas flow ranges from 8.16 kg/s to 12.95 kg/s, and calculate the primary energy ratio, the exergy efficiency, the per-unit emission amount of the CO₂, the per-unit thermoeconomic cost, the operating load, and the outlet flue gas temperature of the gas turbine of the system under the operating conditions;

Then, according to simulation results, perform fitting, by means of a fitting analysis tool of a matrix laboratory (matlab), on the operating load (f_{Load}), the primary energy ratio (f_{Q}), the exergy efficiency (f_{Exergy}), the per-unit emission amount (f_{CO2}) of the CO₂, the per-unit thermoeconomic cost (f_{Cost}), and the outlet flue gas temperature (f_{T}) of the gas turbine to obtain the adaptive function group related to the IGV opening (x), the natural gas flow (y), and the natural gas price (m); and

After the optimization objective, the constraint conditions, and the adaptive function group are determined, build the operation optimization model according to a calculation process of the particle swarm optimization by writing calculation codes through the matlab.

Where, the adaptive function group fᵢ of the combined cycle gas turbine system in spring, summer, autumn, and winter is respectively denoted by f₁, f₂, f₃, and f₄.

The adaptive function group f₁ of the combined cycle gas turbine system in the city in spring is expressed by formula (5-2) to formula (5-7).

f(x,y)_{Load,1}=−39.82−1.299x+16.71y−3.76×10⁻³x²+1.352×10⁻¹xy−5.432×10⁻¹y² (5-2)

f(x,y)_{Q,1}=−11.14−0.1561x+4.156y−4.172x²+3.559×10⁻²xy−4.933y²+4.894×10⁻⁵x²y−2.055×10⁻³xy²+1.953×10⁻²y³ (5-3)

f(x,y)_{Exergy,1}=−11.18−0.1519x+4.176y−3.759×10⁻⁴x²+0.03502xy−0.4983y²−2.055×10⁻³xy²+1.988×10⁻²y³ (5-4)

f(x,y)_{cO}_{₂}_{,1}=7.322×10⁴+869.3x−2.554×10⁴y+2.163x²−201.2xy+3023y²−0.266x²y+11.77xy²−119.3y³ (5-5)

f(x,y,m)_{Cost,1}=7.781×10⁻⁴x−4.6×10⁻²y+2.94×10⁻³m+0.98307 (5-6)

f(x,y)_{T,1}=−747.1+11.37x+283.2y+0.5083x²−6.306xy−13.81y²+1.353×10⁻³x³−5.5923×10⁻²x²y+0.4919xy² (5-7)

The adaptive function group f₂ of the combined cycle gas turbine system in the city in summer is expressed by formula (5-8) to formula (5-13).

f(x,y)_{Load,2}=−4.629−0.791x+8.157y−2.646×10⁻³x²+8.492×10⁻²xy−3.372×10⁻²y² (5-8)

f(x,y)_{Q,2}=0.4564−4.809×10³x+7.441×10⁻³y−1.372×10⁻⁵×²+4.736×10⁻⁴xy (5-9)

f(x,y)_{Exergy,2}=3.344−0.256x+0.7119y−3.362×10⁻³x²+0.06578xy−0.04461y²−4.452×10⁻⁴x²y−4.222×10⁻³xy² (5-10)

f(x,y)_{CO}_{₂}_{,2}=1.612×10⁴+98.33x−4862y−19.3xy+532.4y²−19.45y³+0.9695xy² (5-11)

f(x,y,m)_{Cost,2}=8.8905×10⁻⁴x−4.789×10⁻²y+3.12×10⁻³m+0.99539 (5-12)

f(x,y)_{T,2}=−4300+67.76x+1675y+0.009236x²+14.13xy−195.4y²+0.0119x²y−0.8473xy²+7.923y³ (5-13)

The adaptive function group f₃ of the combined cycle gas turbine system in the city in autumn is expressed by formula (5-14) to formula (5-19).

f(X,y)_{Load,3}=−66.1−1.642x+23.3y−4.866×10⁻³x²+0.1824xy−0.9448y² (5-14)

f(x,y)_{Q,3}=−1.081−0.01798x+0.5048y+2.988×10⁻³xy−0.05288y²+1.294×10⁻⁴xy²+1.873×10⁻³y² (5-15)

f(x,y)_{Energy,3}=−1.79−0.02354x+0.7238y+4.063×10⁻³xy0.07589y²−1.809×10⁻⁴xy²−2.669×10⁻³y³ (5-16)

f(x,y)_{cO}_{₂}_{,3}=1330+19.58x+2.957y−0.05214x²−2.204xy−6.154×10⁻⁴x³+0.01502x²y (5-17)

f(x,y,m)_{cost,3}=8.6461×10⁻⁴x−4.697×10⁻²y+3.12×10⁻³m+0.9854 (5-18)

f(x,y)_{T,3}=149.2−9.069x+5957y+0.1118x²+0.2542xy+0.007161x²y (5-19)

The adaptive function group f₄ of the combined cycle gas turbine system in the city in winter is expressed by formula (5-20) to formula (5-25).

f(x,y)_{Load,4}234.4−2.574x+82.17y+0.4274xy−7.924y²−0.01855xy²+0.2834y³ (5-20)

f(x,y)_{Q,4}=−0.9701—0.04801x+0.3477y+8.818×10⁻⁴x²+0.01463xy−0.0198y²+1.017×10⁻³Xy²+1.075×10⁻⁴x²y (5-21)

f(x,y)_{Exergy,4}=−1.032−0.0612x+0.3541y+1.07x−0.01786xy−0.01995y²−1.283×10⁻⁴x²y+1.206×10⁻³xy² (5-22)

f(x,y)_{CO}_{₂}_{,4}=13490+105.8x−3862y−18.77xy+404.1y²+0.8465xy²−14.02y³ (5-23)

f(x,y,m)_{Cost,4}=7.37246×10⁻⁴x−0.04496y+0.0031m+0.96814 (5-24)

f(x,y)_{T,4}=−823.3+25.74x+298.6y+0.7508x²−10.1xy−14.69y²+2.184×10⁻³x³−0.08908x²y+0.7366xy² (5-25)

The goodness of fit R2 of adaptive functions of the system in spring is 0.999, 0.983, 0.971, 0.949, 0.991, and 0.998 respectively; and if all values of the R2 are approximate to 1, the adaptive function group can commendably reflect a functional relationship between optimized parameters and the optimization objective and between the optimized parameters and the constraint conditions.

The IGV opening and natural gas flow of the combined cycle gas turbine system in the city in different seasons are optimized by means of the optimization model (as shown in FIG. 9 to FIG. 12). The primary energy ratio, the exergy efficiency, the per-unit emission amount of the CO₂, and the per-unit thermoeconomic cost of an optimized system are analyzed by comparing overall evaluation results of the optimized system with overall evaluation results of a non-optimized system.

The overall evaluation results of the optimized system under different load conditions are higher than those of the non-optimized system. When the load of the system is 80%, the system is optimized to the greatest extent and has the overall evaluation result increased by 0.1576.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A method for optimizing operation of a combined cycle gas turbine system, comprising the following steps:
S1, building a process flow model of a gas-fired power generation system as well as a process flow model of a steam power generation system;
S2, determining energy efficiency indexes and an environmental evaluation index of a combined cycle gas turbine system, wherein a primary energy ratio and exergy efficiency of the system are served as the energy efficiency indexes of the system, and mass of CO₂ emitted by the system to generate per-unit electricity is served as the environmental evaluation index;
S3, determining thermoeconomic evaluation indexes of the combined cycle gas turbine system;
S4, building an overall evaluation model by analyzing, through an entropy weight method, weight indexes such as the primary energy ratio, the exergy efficiency, a per-unit emission amount of the CO₂, and a per-unit thermoeconomic cost of the system; particularly:
S41, normalization of the indexes
firstly, totally numbering m operating conditions, participating in evaluation, of the system as M, wherein M=(m₁, m₂, m₃ mₘ); totally numbering n evaluation indexes of the system as D, wherein D=(d₁, d₂, d₃ dₙ); and recording a value of the i^{th} evaluation index of the evaluated operating condition mᵢ as xᵢⱼ to form an evaluation index matrix X=[xᵢⱼ]_{m*n} composed of m*n indexes;
$$X = [ \begin{matrix}{x}_{11} & {x}_{12} & L & {x}_{1 n} \\ {x}_{21} & {x}_{22} & L & {x}_{2 n} \\ M & M & O & M \\ {x}_{m 1} & {x}_{m 2} & L & {x}_{m n}\end{matrix} ] \qquad ( 4 - 1 )$$
then, normalizing the indexes based on types of the indexes, wherein the indexes expressing performance improved with an increase in values of evaluation results are normalized according to formula (4-2), and indexes expressing the performance improved with a decrease in the values of the evaluation results are normalized according to formula (4-3);
$${V}_{ij} = \frac{{x}_{ij} - min ( {x}_{j} )}{max ( {x}_{j} ) - min ( {x}_{j} )} \qquad ( 4 - 2 )$$
$${V}_{ij} = \frac{max ( {x}_{j} ) - {x}_{ij}}{max ( {x}_{j} ) - min ( {x}_{j} )} \qquad ( 4 - 3 )$$
in formula (4-2) and formula (4-3), min(xⱼ) represents the minimum value of the j^{th} evaluation index under the operating conditions; and
max(xⱼ) represents the maximum value of the j^{th} evaluation index under the operating conditions;
and finally, calculating a proportion of features of the i^{th} load condition in the presence of the j^{th} evaluation index to form a normalized matrix P expressed by formula (4-4);
$${P}_{i j} = \frac{{V}_{i j}}{{{\sum }_{i = 1}}^{m} {V}_{i j}} \qquad ( 4 - 4 )$$
in formula (4-4), Vᵢⱼ represents a value of a normalized and dimensionless index xᵢⱼ; and
Pᵢⱼ represents the proportion of the features;
S42, information entropy calculation on the indexes
working out a value of information entropy corresponding to the j^{th} evaluation index according to formula ((4-5);
$${e}_{j} = - 1 / ln ( m ) {\sum }_{i = 1}^{m} {p}_{ij} \cdot ln {p}_{ij} \qquad ( 4 - 5 )$$
in formula (4-5), eⱼ represents the value of the information entropy of the i^{th} evaluation index; and Pᵢⱼ represents the proportion of the features;
S43, weight calculation on the indexes
working out a difference coefficient of the evaluation index Xⱼ according to formula (4-6), and
working out an entropy weight wⱼ of the j^{th} evaluation index according to formula (4-7):
$${d}_{j} = 1 - {e}_{j} \qquad ( 4 - 6 )$$
$${w}_{j} = \frac{{d}_{j}}{{\sum }_{j = 1}^{n} {d}_{j}} \qquad ( 4 - 7 )$$
in formula (4-6) and formula (4-7), dⱼ represents a difference of the j^{th} evaluation index; and
wⱼ represents a weight ratio of the j^{th} evaluation index;
S44, calculation on overall evaluation indexes
wherein, an overall effectiveness evaluation index Kᵢ under the i^{th} operating condition is as follows:
$${K}_{i} = {\sum }_{j = 1}^{n} {w}_{j} {V}_{ij} \qquad ( 4 - 8 )$$
in formula (4-8), Vᵢⱼ represents a value of a normalized and dimensionless index xᵢⱼ; and
S5, building an optimization model by means of particle swarm optimization.

2. The method for optimizing operation of a combined cycle gas turbine system according to claim 1, wherein step S5 particularly comprises: setting the overall evaluation model as an optimization objective; establishing constraint conditions of the system; establishing an adaptive function group; and after the optimization objective, the constraint conditions, and the adaptive function group are determined, building the operation optimization model according to a calculation process of the particle swarm optimization.

3. The method for optimizing operation of a combined cycle gas turbine system according to claim 2, wherein in the adaptive function group, independent variables include inlet guide vane (IGV) opening to be optimized, natural gas flow, and a natural gas price having an influence on the per-unit thermoeconomic cost of the system; and dependent variables include the primary energy ratio, the exergy efficiency, the per-unit emission amount of the CO₂, and the per-unit thermoeconomic cost which are related to the optimization objective, as well as an operating load of the system and an outlet flue gas temperature of a gas turbine, which are related to the constraint conditions.

4. The method for optimizing operation of a combined cycle gas turbine system according to claim 1, wherein in step S1, the process flow model of the gas-fired power generation system as well as the process flow model of the steam power generation system are built based on an actual production process of the combined cycle gas turbine system by means of process simulation software, namely Aspen Plus, and thermodynamic models of devices of the combined cycle gas turbine system.

5. The method for optimizing operation of a combined cycle gas turbine system according to claim 1, wherein in step S2, a primary energy ratio index is established by analyzing, based on energy analysis, an energy balance among a gas turbine system, a waste heat boiler system, and a steam turbine system; an exergy efficiency index is established by analyzing, based on energy analysis, an exergy balance among main devices of the system; and components of a flue gas from the system is analyzed, and the mass of the CO₂ emitted by the system to generate the per-unit electricity is served as the environmental evaluation index.

6. The method for optimizing operation of a combined cycle gas turbine system according to claim 1, wherein in step S3, thermoeconomic models are built through the following steps:
S31, drawing a productive structure diagram of the system according to a productive consumption relationship between fuels and the devices of the system and between products and the devices of the system;
S32, building fuel-product calculation models of the devices of the system, to determine the fuels and the products; and
S33, building the thermoeconomic models of the devices of the system to analyze a thermoeconomic cost of the system.
